(19) United States
(12) Patent Application Publication
(10) Pub. No.: US 2008/0077805 A1
(43) Pub. Date: Mar. 27, 2008

(54) Securing Data Exchanged in Memory

(76) Inventors: Ryan C. Catherman, Raleigh, NC (US); David C. Challener, Raleigh, NC (US); James P. Hoff, Raleigh, NC (US); John H. Nicholson, Durham, NC (US)

Correspondence Address: Driggs, Hogg, Daugherty & Del Zoppo Co., L.P.A., 38500 CHARDON ROAD, DEPT. LEN, WILLOUGHBY HILLS, OH, 44094, US

(21) Appl. No.: 11/535,135

(22) Filed: Sep. 26, 2006

(51) Int. Cl. G06F 12/14

(52) U.S. Cl. 713/190

(57) ABSTRACT

Data exchanged between memory components is protected against possible misuse and breach of security by providing for encryption of data swapped out to another location such as a disk drive.

### FIELD AND BACKGROUND OF INVENTION

This invention relates to securing data within a computer system. More particularly, this invention addresses a security fault which arises out of the operation of an operating system in managing memory allocation.

Operating systems used in computer systems typically must deal with memory allocation issues, as few systems have sufficient memory available for all processes which may be chosen to run at any given moment to have use of such memory as the process may require or desire. Thus it is commonplace for data to be temporarily exchanged between locations in available memory components. This is often referred to as “swapping” and will be known as such to persons of skill in the applicable arts.

Swapping may occur because a process of higher priority requires memory locations in the system working memory (typically semiconductor random access memory or RAM) which are temporarily occupied by data being manipulated by a process of lower priority. When this occurs, system software will swap the lower priority data out to another memory component. Frequently, and particularly in personal computer systems, the swap is between system memory and a disk drive.

The present invention contemplates the situation where the data to be swapped out (and then later swapped back in when the related process recovers use of system memory) is data which has security value. A problem arises in that the swapped out data may comprise secret or private information which would normally be handled in a secure mode. Yet when exchanged between memory components, the possibility is open that the data may remain in the temporary location and be recoverable by a pursuing party.

Secure processing will often encrypt data of a sensitive nature, such as passwords. However, swapping as here described, should it occur during an encryption process, will likely result in unencrypted data, such as passwords, remaining in the disk drive swap file.

### SUMMARY OF THE INVENTION

With the foregoing in mind, this invention assures that data exchanged between memory components is protected against possible misuse and breach of security. In doing so, the present invention provides for encryption of data swapped out to another location such as a disk drive.

### BRIEF DESCRIPTION OF DRAWINGS

Some of the purposes of the invention having been stated, others will appear as the description proceeds, when taken in connection with the accompanying drawings, in which:

FIG. 1 is a block diagram representation of an illustrative computer system in which the present invention will have utility;

FIG. 2 is a flow chart of operations contemplated by this invention; and

FIG. 3 is a representation of a computer readable medium on which instructions contemplated by this invention may be stored.

### DETAILED DESCRIPTION OF INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

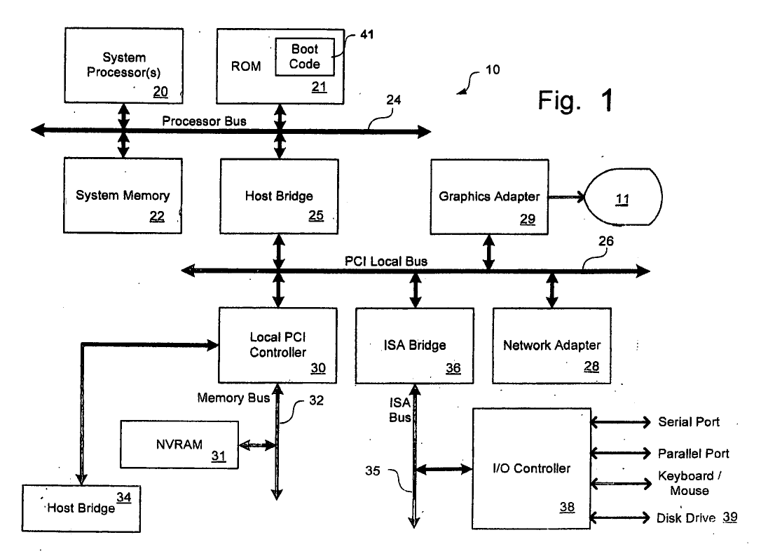

FIG. 1 is one illustrative embodiment of a computer system which includes a system processor or CPU 20, coupled to a Read-Only Memory (ROM) 21 and a system memory 22 by a processor bus 24. System processor 20 is a general-purpose processor that executes boot code stored within ROM 21 at power-on and thereafter processes data under the control of an operating system and application software stored in system memory 22. System processor 20 is coupled via the processor bus 24 and a host bridge 25 to a Peripheral Component Interconnect (PCI) local bus 26. The system processor, ROM, system memory and other devices may be semiconductors housed in conventional packages and mounted on a printed circuit board known as a motherboard.

The PCI local bus 26 supports the attachment of a number of devices, including adapters and bridges. Among these devices is a network adapter or NIC 28, which interfaces the computer system 10 to a LAN (wired or wireless), and graphics adapter 29, which interfaces the computer system 10 to a display. Communication on the PCI local bus 26 is governed by a local PCI controller 30, which is in turn coupled to non-volatile random access memory (NVRAM) 31 via a memory bus 32. Local PCI controller 30 can be coupled to additional buses and devices via a second host bridge 34.

Computer system 10 further may include an Industry Standard Architecture (ISA) bus 35, which is coupled to the PCI local bus 26 by an ISA bridge 36. Coupled to the ISA bus 35 is an input/output (I/O) controller 38, which controls communication between computer system 10 and attached peripheral devices such as a keyboard 12, mouse 13, and a disk drive 39 on which software is stored as digital data. In addition, I/O controller 38 supports external communication by computer system 10 via serial and parallel ports. Alternatively, more recently designed systems may use a PCI Express service for such functions as graphics.

As mentioned above, one function of software controlling the operation of the system 10 is to allocate memory in the system memory 22. In the process of allocating addresses in that memory component, data will be exchanged with other memory components, typically with a disk drive 39 where a “swap file” may exist. It is precisely this swapping between memory components that gives rise to the security problem addressed by this invention.

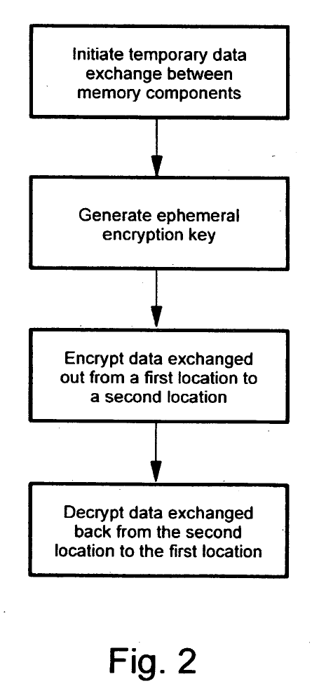

As contemplated by this invention, computer instructions are stored accessibly to the central processor 20 and executable by that processor for processing data, the instructions having elements directing the temporary exchange of data among a plurality of memory components as described here. Additionally, security computer instructions are stored accessibly to the central processor 20 and executable to (a) generate an encryption key prior to a temporary exchange of data between two memory components and (b) encrypt data to be temporarily exchanged (see FIG. 2). The security computer instructions apply the encryption key to decrypt data being returned from a temporary exchange. Thus while a swap file on the disk may exist after completion of the exchange or swap, the data in that file is encrypted and unreadable by any application or program other than the one from which it was “swapped out”.

The present invention contemplates that the memory components comprise system memory 22 and a disk drive 39, and that the temporary exchange of data is between the system memory and a disk drive. The security computer instructions are executed in said central processor. However, the present invention contemplates that the security key may be generated either in the processor or in the host bridge 25. The encryption key is ephemeral. That is, the encryption key exists only for the interval of time required for the exchange to be completed and then vanishes so as to be unrecoverable after the related task is completed.

Regarding the encryption key, the extent to which the key is ephemeral may depend upon whether the key exists only for the one swap exchange or exists for so long as the related process is running. That is, the author of code implementing this invention has a design choice—either the key may be in existence for only a short time—the time of one exchange—or a longer time—the interval that the related process is executing (such as a word processing or spreadsheet program). Another characteristic of the key is that during its existence, for whatever time that may be, it is stored in a memory location which is unknown to, and inaccessible by, other processes and processors running in the system. Thus the key is concealed during its interval of existence in addition to being in existence for only a limited time.

From this description, it will be understood that the present invention contemplates a method of securing data undergoing such an exchange by executing computer instructions in a computer system to process data; temporarily exchanging data from a first memory location to a second memory location as memory demands fluctuate; responding to a temporary exchange by generating an encryption key and applying the generated key to encrypt data being exchanged into the second memory location; and responding to a reversal of the temporary exchange by applying the generated key to decrypt the data which has been exchanged. Such a method will include other steps such as creating an ephemeral key, executing the controlling code in the central processor, or generating the key within a bridge in the system.

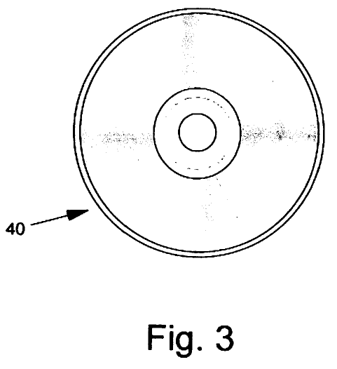

FIG. 3 illustrates one form of computer readable media 40 on which the instructions appropriate to carrying out this invention may be stored accessibly to a computer system.

In the drawings and specifications there has been set forth a preferred embodiment of the invention and, although specific terms are used, the description thus given uses terminology in a generic and descriptive sense only and not for purposes of limitation.

What is claimed is:

1. Apparatus comprising:
a computer system having a central processor and a plurality of memory components;
computer instructions stored accessibly to said central processor and executable by said central processor for processing data, said instructions having elements directing the temporary exchange of data among said plurality of memory components; and
security computer instructions stored accessibly to said central processor and executable to generate an encryption key prior to a temporary exchange of data between two memory components and encrypt data to be temporarily exchanged;
said security computer instructions applying said encryption key to decrypt data being returned from a temporary exchange.

2. Apparatus according to claim 1 wherein said memory components comprise system memory and a disk drive.

3. Apparatus according to claim 1 wherein the temporary exchange of data is between system memory and a disk drive.

4. Apparatus according to claim 1 wherein said security computer instructions are executed in said central processor.

5. Apparatus according to claim 1 wherein said system has a host bridge and further wherein said encryption key is generated in said host bridge.

6. Apparatus according to claim 1 wherein said encryption key is ephemeral.

7. Apparatus according to claim 6 wherein said encryption key is stored during its existence in a memory location unknown to and inaccessible by other system processes and processors.

8. Method comprising:
executing computer instructions in a computer system to process data;
temporarily exchanging data from a first memory location to a second memory location as memory demands fluctuate;
in response to a temporary exchange, generating an encryption key and applying the generated key to encrypt data being exchanged into the second memory location; and
in response to a reversal of the temporary exchange, applying the generated key to decrypt the data which has been exchanged.

9. Method according to claim 8 wherein the temporary exchange of data is between system memory and a disk drive.

10. Method according to claim 8 wherein the security computer instructions are executed in the central processor.

11. Method according to claim 8 wherein the generation of the encryption key occurs in a host bridge.

12. Method according to claim 8 wherein the encryption key is ephemeral.

13. Method according to claim 12 wherein the encryption key is stored during its existence in a memory location unknown to and inaccessible by other system processes and processors.

14. A program product comprising:
a computer readable medium;
computer executable code stored on said medium which, when executing in a system having a central processor and a plurality of memory components,
temporarily exchanges data from a first memory location to a second memory location as memory demands fluctuate;
in response to a temporary exchange, generates an encryption key and applies the generated key to encrypt data being exchanged into the second memory location; and
in response to a reversal of the temporary exchange, applies the generated key to decrypt the data which has been exchanged.

15. A program product according to claim 14 wherein the computer executable code, when executing, temporarily exchanges data between system memory and a disk drive.

16. A program product according to claim 14 wherein the security computer instructions execute in the central processor.

17. A program product according to claim 14 wherein the generation of the encryption key occurs in a host bridge.

18. A program product according to claim 14 wherein the encryption key is ephemeral.

19. A program product according to claim 18 wherein the encryption key is stored during its existence in a memory location unknown to and inaccessible by other system processes and processors.

20. Method comprising:
producing computer executable program code;
providing the program code to be deployed to and executed on a computer system, the program code comprising instructions which:
temporarily exchange data from a first memory location to a second memory location as memory demands fluctuate;
in response to a temporary exchange, generates an encryption key and applies the generated key to encrypt data being exchanged into the second memory location; and
in response to a reversal of the temporary exchange, applies the generated key to decrypt the data which has been exchanged.
